(19) United States
(12) Patent Application Publication
(10) Pub. No.: US 2018/0350026 A1
(43) Pub. Date: Dec. 6, 2018

(54) MEMORY FOOTPRINT AND POWER EFFICIENT MULTI-PASS IMAGE PROCESSING ARCHITECTURE

(71) Applicant: QUALCOMM Incorporated, San Diego, CA (US)

(72) Inventors: Jeffrey Hao Chu, San Diego, CA (US); Suolong Dong, San Diego, CA (US)

(21) Appl. No.: 15/608,889

(22) Filed: May 30, 2017

(51) Int. Cl. G06T 1/20; G06T 1/00; G06T 3/40; G06T 1/60

(52) U.S. Cl. CPC G06T 1/20; G06T 1/60; G06T 3/40; G06T 1/0007

(57) ABSTRACT

A system and method are disclosed for processing image data. An example method includes sequentially receiving a plurality of raster lines corresponding to an image, and grouping the plurality of raster lines into a plurality of full-scale horizontal stripes of image data. For each full-scale horizontal stripe of image data, the method: generates a first downscaled version of the full-scale horizontal stripe, generates a full-scale rotated stripe by rotating the full-scale horizontal stripe to a vertical orientation, generates a first downscaled rotated stripe by rotating the first downscaled version of the full-scale horizontal stripe to the vertical orientation, and performs image processing on the full-scale rotated stripe and the first downscaled rotated stripe before all subsequent raster lines of the image have been received.

### TECHNICAL FIELD

The example embodiments relate generally to image processing, and more specifically, to multi-pass image processing.

### BACKGROUND OF RELATED ART

A number of image processing systems use multi-pass architectures. In such architectures, multiple downscaled versions of an image may be sequentially processed. For example, a full-scale image (1:1 scale) may be received by an image front end (e.g., received from an image sensor), and a number of downscaled resolution versions of that full-scale image may be generated, such as a 1:4 scale, and a 1:16 scale. The full-scale image and the downscaled images may be stored in a memory—such as in a random access memory (RAM). An image processor may then process the images sequentially from lower resolutions to higher resolutions. For example, such an image processor may process the 1:16 scale image, then the 1:4 scale image, and finally the 1:1 full-scale image. Such techniques may be used for image processing such as two-dimensional filtering, de-mosaicing, lens rolloff correction, scaling, color correction, color conversion, noise reduction filtering, spatial filtering, scale space image processing, and other image processing applications.

Multi-pass processing can allow for higher quality image processing at a relatively low cost. For example, multi-pass architectures can allow for effective kernel sizes of filters to be significantly larger than their actual size as implemented.

One aspect of conventional multi-pass architectures is that the larger resolution images cannot be processed or discarded before the smaller resolution images are processed. This sequential dependency can be costly for high resolution images. For example, significant bandwidth may be expended writing each full-scale image into RAM. This may result in significant power consumption, particularly if the RAM is off-chip. It may also result in one extra frame delay of a preview stream corresponding to the processed images, as the full-scale image is copied to RAM, and then fetched for further processing. If on-chip memory or caching is used, this bandwidth and power consumption and extra frame delay may be reduced, but may require a large amount of such on-chip memory, which may be costly to implement.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and apparatus for processing image data. An example method may include sequentially receiving a plurality of raster lines corresponding to an image, and grouping the received plurality of raster lines into a plurality of full-scale horizontal stripes of image data. For each full-scale horizontal stripe of image data, the method may include generating a first downscaled version of the full-scale horizontal stripe, generating a full-scale rotated stripe by rotating the full-scale horizontal stripe to a vertical orientation, generating a first downscaled rotated stripe by rotating the first downscaled version of the full-scale horizontal stripe to the vertical orientation, and performing image processing on the full-scale rotated stripe and the first downscaled rotated stripe before all subsequent raster lines of the image have been received.

In another example, an image processing system configured to process an image is disclosed. The image processing system includes an image front end (IFE) to sequentially receive a plurality of raster lines corresponding to the image, and group the received plurality of raster lines into a plurality of full-scale horizontal stripes of image data. The image processing system also includes one or more processors, and a first memory storing instructions that, when executed by the one or more processors, cause the image processing system to, for each full-scale horizontal stripe of image data: generate a first downscaled version of the full-scale horizontal stripe, generate a full-scale rotated stripe by rotating the full-scale horizontal stripe to a vertical orientation, generate a first downscaled rotated stripe by rotating the first downscaled version of the full-scale horizontal stripe to the vertical orientation, and perform image processing on the full-scale rotated stripe and the first downscaled rotated stripe before all subsequent raster lines of the image have been received by the IFE.

In another example, a non-transitory computer readable storage medium is disclosed, storing instructions that when executed by one or more processors of an image processor, cause the image processor to process an image by performing operations including sequentially receiving a plurality of raster lines corresponding to an image, and grouping the received plurality of raster lines into a plurality of full-scale horizontal stripes of image data. For each full-scale horizontal stripe of image data, the operations may include generating a first downscaled version of the full-scale horizontal stripe, generating a full-scale rotated stripe by rotating the full-scale horizontal stripe to a vertical orientation, generating a first downscaled rotated stripe by rotating the first downscaled version of the full-scale horizontal stripe to the vertical orientation, and performing image processing on the full-scale rotated stripe and the first downscaled rotated stripe before all subsequent raster lines of the image have been received.

In another example, an image processing system configured to process an image is disclosed. The image processing system includes means for sequentially receiving a plurality of raster lines corresponding to an image, and means for grouping the received plurality of raster lines into a plurality of full-scale horizontal stripes of image data. For each full-scale horizontal stripe of image data, the image processing system may include means for generating a first downscaled version of the full-scale horizontal stripe, means for generating a full-scale rotated stripe by rotating the full-scale horizontal stripe to a vertical orientation, means for generating a first downscaled rotated stripe by rotating the first downscaled version of the full-scale horizontal stripe to the vertical orientation, and means for performing image processing on the full-scale rotated stripe and the first downscaled rotated stripe before all subsequent raster lines of the image have been received.

### BRIEF DESCRIPTION OF THE DRAWINGS

The example embodiments are illustrated by way of example and are not intended to be limited by the figures of the accompanying drawings, where:

FIG. 1 shows a block diagram of a multi-pass image processing system.

FIG. 2 shows a block diagram of a stripe-based multi-pass image processing system.

FIG. 3 shows a block diagram of another stripe-based multi-pass image processing system.

FIG. 4 shows a block diagram of a stripe-based multi-pass image processing system, according to the example embodiments.

FIG. 5 shows a block diagram of another stripe-based multi-pass image processing system, according to the example embodiments.

FIG. 6 shows a multi-pass stripe-based image processing device within which the example methods may be performed.

FIG. 7 shows a flow chart of an example operation for processing an image, according to the example embodiments.

Like reference numerals refer to corresponding parts throughout the drawing figures.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the relevant art to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the example embodiments. Also, the example image processing devices may include components other than those shown, including well-known components such as one or more processors, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or another processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein, for example software modules or hardware modules comprising stages in one or more image processing pipelines. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The example embodiments are not to be construed as limited to specific examples described herein but rather to include within their scopes all embodiments defined by the appended claims.

As mentioned above, conventional multi-pass image processing architectures receive a full-scale image, generate one or more downscaled versions of the full-scale image, and process the full-scale image and the one or more downscaled versions. Such architectures can allow for increased effective kernel sizes as compared to non-multi-pass architectures. However, such architectures can introduce sequential dependency, where the larger resolution copies of the image to be processed cannot be processed or discarded before the smaller resolution images are processed. This sequential dependency can result in significant power consumption and bandwidth if off-chip RAM is used for storing the multiple copies of the image, and can require significant and costly amounts of on-chip memory if local caching is used instead. The requirement that all smaller resolution images are processed before the larger scale images can also introduce a frame delay—for example a frame delay in a preview stream corresponding to the processed image.

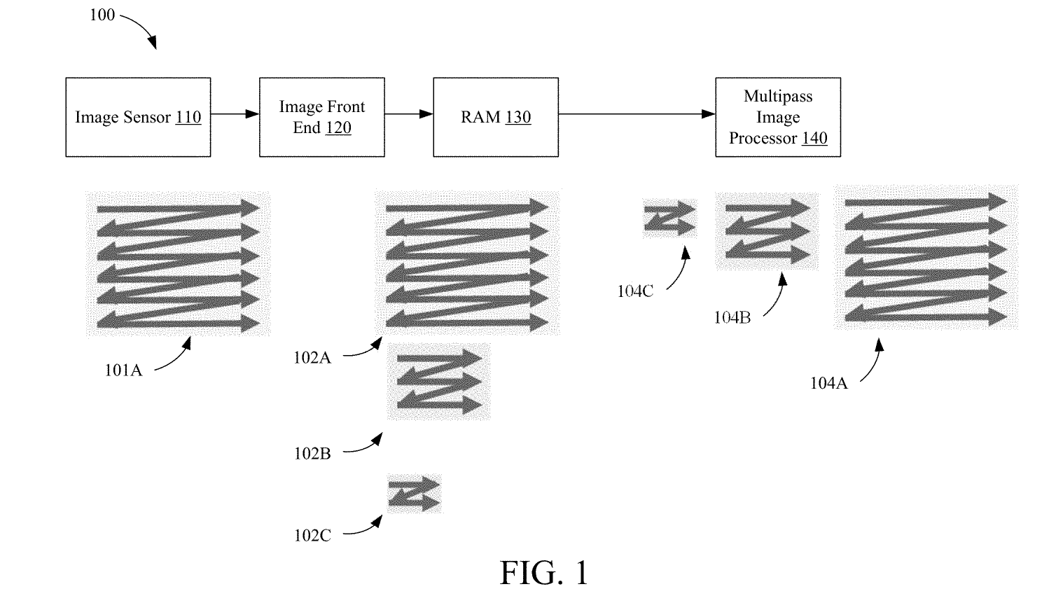

FIG. 1 is a block diagram showing a conventional multi-pass image processing system 100. The multi-pass image processing system 100 includes an image sensor 110, an image front end (IFE) 120, random access memory (RAM) 130, and a multipass image processor (MPIP) 140. Note that MPIP 140 may include one or more hardware or software stages of an image processing pipeline (not shown for simplicity). As shown with respect to FIG. 1, the image sensor 110 may capture an image as a sequence of raster lines, as shown in image 101A. These raster lines may be sequentially sent to IFE 120. The IFE 120 may then output the pixels of those raster lines concurrently as a full-scale resolution image 102A, and as one or more downscaled resolution images corresponding to the full-scale resolution image 102A—images 102B and 102C in FIG. 1. These images 102A-102C are then stored in a memory, for example in RAM 130 as shown in FIG. 1. Note that in some other multi-pass image processing systems, local cache memory may be used for storing these images rather than RAM 130. The MPIP 140 may then read and process these images in order of their resolution (small to large). In other words, the MPIP 140 may first read and process the smallest downscaled image 104C, then the next smallest downscaled image 104B, and finally the full-scale image 104A. Note that while two downscaled images are shown in FIG. 1, any number of downscaled images may be generated and processed by the multi-pass image processing system 100.

Note that the sequential dependency of such architectures results in the MPIP 140 being unable to process or discard full-scale image 104A until the lower resolution images 104B and 104C have been processed. As discussed above, this may be costly, as the required memory for storing each full-scale image can be quite large. In addition, if off-chip RAM (such as RAM 130) is used for storing the images 102A-102C, then the bandwidth required for storing these images, and then for the MPIP 140 to read the images can be considerable. For example, for ultra-high definition (UHD) resolution images (i.e., having a full-scale resolution of 3840×2160 pixels), approximately 24 MB of data may be required to be buffered for electronic image stabilization (EIS), or 16 MB without EIS. The bandwidth and power consumed may be several gigabytes per second (GB/s) or several hundred milliwatts (mw) for UHD 60 (UHD resolution at 60 frames per second) if EIS is used. As resolutions and framerates continue to increase, this bandwidth and power consumption may become even more problematic.

In addition, some image multi-pass image processors employ stripe-based processing. In such systems, the full-scale image and the downscaled images are divided into stripes for processing. Such stripe-based processing can allow for cost savings in an MPIP, for example by allowing an MPIP to use smaller line buffers.

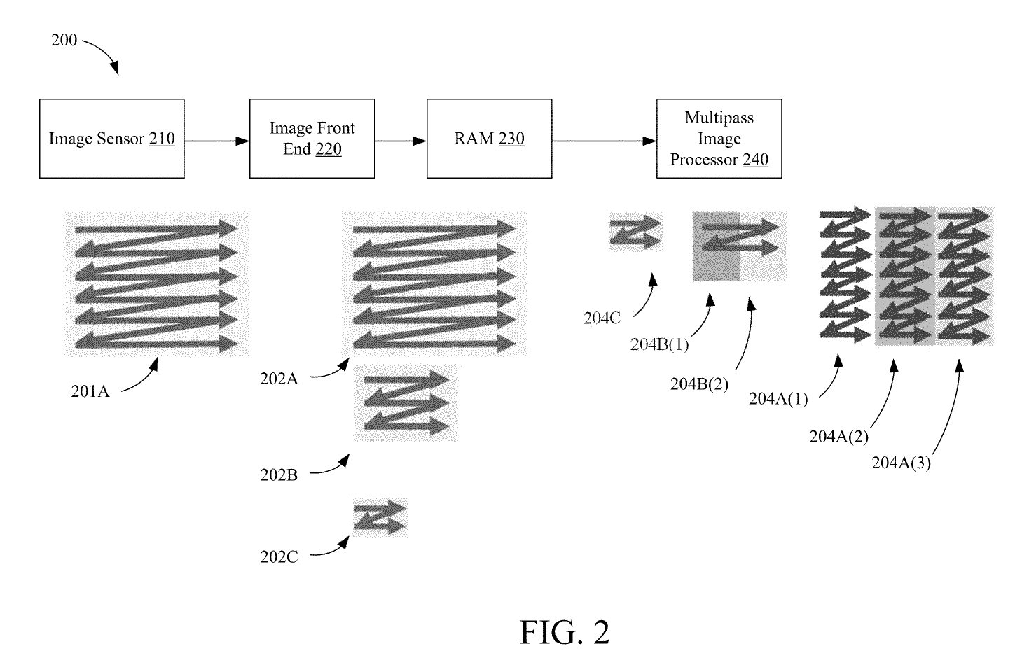

FIG. 2 shows an example stripe-based multi-pass image processing system 200. The stripe-based multi-pass image processing system 200 includes an image sensor 210, an IFE 220, RAM 230, and a MPIP 240. Note that MPIP 240 may include one or more hardware or software stages of an image processing pipeline (not shown for simplicity). In the example of FIG. 2, the image sensor 210 may capture an image as a sequence of raster lines, as shown in image 201A. These raster lines may be sequentially sent to IFE 220. The IFE 220 may then output the pixels of those raster lines concurrently as a full-scale resolution image 202A, and as one or more downscaled resolution images corresponding to the full-scale resolution image 202A—images 202B and 202C in FIG. 2. These images 202A-202C may then be stored in a memory, for example in RAM 230 as shown in FIG. 2. Note that in some multi-pass image processing systems, local cache memory may be used for storing these images rather than RAM 230. The MPIP 240 may then read and process these images in an increasing order of their resolutions. In other words, the MPIP 240 may first read and process the smallest downscaled image 204C, then the next smallest downscaled image 204B, and finally the full-scale image 204A.

However, where MPIP 140 processes each of images 104A-104C of FIG. 1 as a whole, MPIP 240 may instead read the downscaled and full-scale images from RAM 230 as a sequence of one or more vertical stripes. For example, the MPIP 240 may read the smallest downscaled image (202C) from RAM 230 as one vertical stripe 204C—in other words, downscaled image 202C is not divided in the example of FIG. 2. On the other hand, downscaled image 202B may be read as two vertical stripes (vertical stripe 204B(1) and vertical stripe 204B(2)), whereas full-scale image 202A may be read as three vertical stripes (vertical stripe 204A(1), vertical stripe 204A(2), and vertical stripe 204A(3)). Stripe-based image processing may improve processing efficiency by dividing the images into a minimum number of stripes, thus maximizing processing efficiency for the smaller resolution downscaled images. In some examples, each stripe has a width which may correspond to a width of one or more line buffers of the image processor. Note that while FIG. 2 shows the full-scale image and the downscaled images divided into one, two and three vertical stripes, in other examples, the full-scale image and the downscaled images may be read by the MPIP 240 in any number of vertical stripes.

MPIP 240 may process the full-scale and the downscaled images in an increasing size order (such as described above with respect to FIG. 1). For example, MPIP 240 may first process vertical stripe 204C, followed by vertical stripes 204B(1) and 204B(2) (which comprise downscaled image 202B), followed by vertical stripes 204A(1), 204A(2) and 204A(3) (comprising full-scale image 202A). Note that while this striped processing allows for cost savings in the MPIP 240, the sequential dependency described above is retained. The associated issues with storage, bandwidth usage, and power consumption may still be costly, and the extra frame delay may still be problematic.

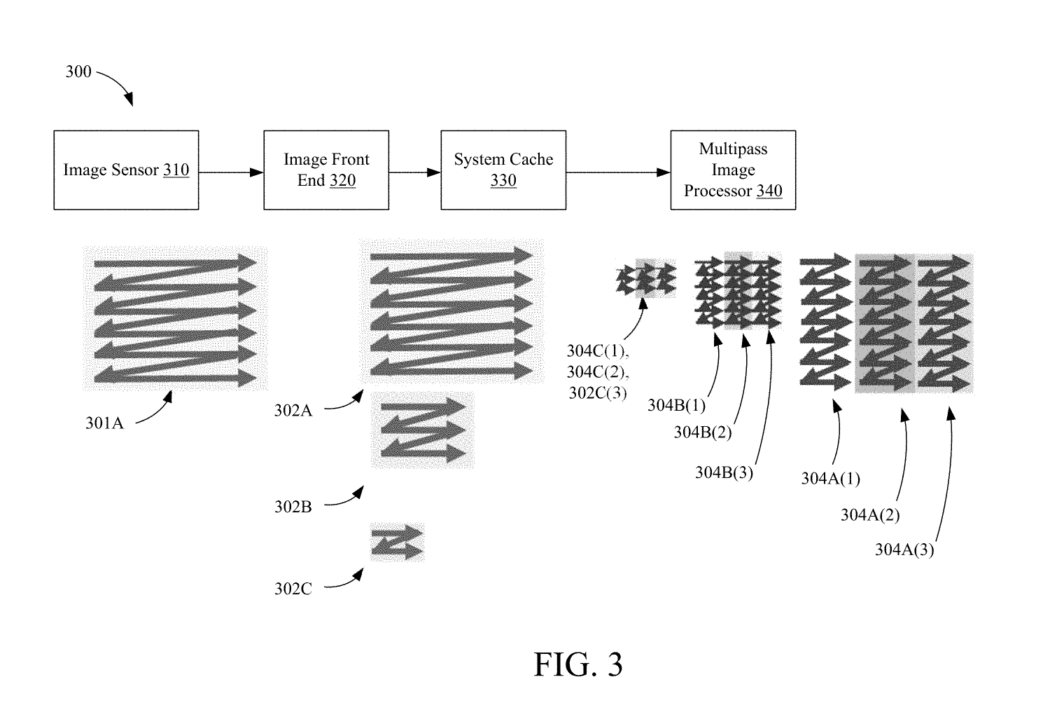

FIG. 3 shows another stripe-based multi-pass image processing system 300. The stripe-based multi-pass image processing system 300 includes an image sensor 310, an IFE 320, system cache 330, and a MPIP 340. Note that MPIP 340 may include one or more hardware or software stages of an image processing pipeline (not shown for simplicity). In the example of FIG. 3, the image sensor 310 may capture an image as a sequence of raster lines, as shown in image 301A, and then sequentially send these lines to IFE 320. IFE 320 may concurrently output full-scale image 302A, and one or more downscaled images 302B and 302C, each corresponding to the full-scale image 302A. Rather than storing these images in RAM (such as RAM 230 of FIG. 2), IFE 320 may store the images in system cache 330. Whereas storing the images in off-chip memory such as RAM 230 may involve sending the images via a bus to the RAM 230, system cache 330 may be on-chip, and may not require the use of such a bus. Using on-chip cache memory rather than off-chip memory such as DDR RAM is also called “tunneling” and may be desirable to reduce memory bandwidth and associated power consumption between the IFE 320 and the MPIP 340. However, enabling multi-pass processing and tunneling using conventional architectures requires a substantial and costly amount of cache memory due to sequential dependency, particularly for high definition video content.

MPIP 340 may then read each of the stored images as an equal number of vertical stripes. For example, with respect to FIG. 3, downscaled image 302C may be read from system cache 330 as three vertical stripes—304C(1), 304C(2), and 304C(3). Downscaled image 302B may also be read as three vertical stripes-304B(1), 304B(2), and 304B(3). Similarly, full-scale image 302A may be read as three vertical stripes—304A(1), 304A(2), and 304A(3). Note that while FIG. 3 shows each image divided into three stripes for simplicity, in other example image processing systems each image may be divided into any number of stripes. The MPIP 340 may then process corresponding stripes in an increasing order of size. For example, MPIP 340 may first process corresponding stripes 304C(1), 304B(1) and 304A(1) in order, and then corresponding stripes 304C(2), 304B(2), and 304A(2) in order, and finally corresponding stripes 304C(3), 304B(3), and 304A(3) in order. Note that while this order of processing is different than the order described with respect to FIG. 2, it exhibits a similar sequential dependency, as the MPIP 240 may not process the full-scale stripes 304A(1)-304A(3) until all of the stripes 304A(1)-304A(3), 304B(1)-304B(3), and 304C(1)-304C(3) have been received by the IFE 320.

It would be advantageous for an image processing system to realize both the performance benefits of multi-pass processing and the cost benefits of stripe-based processing, while minimizing or avoiding the sequential dependence of the previously described image processing systems. Accordingly, the example embodiments described herein provide for stripe-based multi-pass image processing systems which allow for an MPIP to process received stripes of image data before all stripes of the captured image have been received by the IFE.

In accordance with the example embodiments, an image processing system may perform both multi-pass and stripe-based image processing, and may reduce or eliminate the sequential dependency of conventional stripe-based multi-pass image processing. The example embodiments may counter that sequential dependency by grouping the raster lines of a received full-scale image and its corresponding downscaled images into sets of horizontal stripes, and rotating each horizontal stripe to generate a set of vertical stripes corresponding to the full-scale horizontal stripe and to each of its corresponding downscaled horizontal stripes. The MPIP may then process sets of corresponding stripes in an increasing order of size, as in FIG. 3. However, because the stripes are rotated, once a first set of corresponding vertical stripes is processed, its stripes no longer need to be stored. In particular, in conventional stripe-based multi-pass image processing systems, the first vertical stripes to be processed contain information from each raster line of the received image—for example, the information for a single raster line of image 301A is typically distributed across each of the vertical stripes 304A(1), 304B(1), and 304C(1). In contrast, in the example embodiments described herein, the first vertical stripes to be processed contain only raster lines from the first horizontal stripe. Consequently, the MPIP does not need to wait for all raster lines of an image to be received before processing the full-scale image, thus significantly reducing the sequential dependency of conventional multi-pass image processing systems.

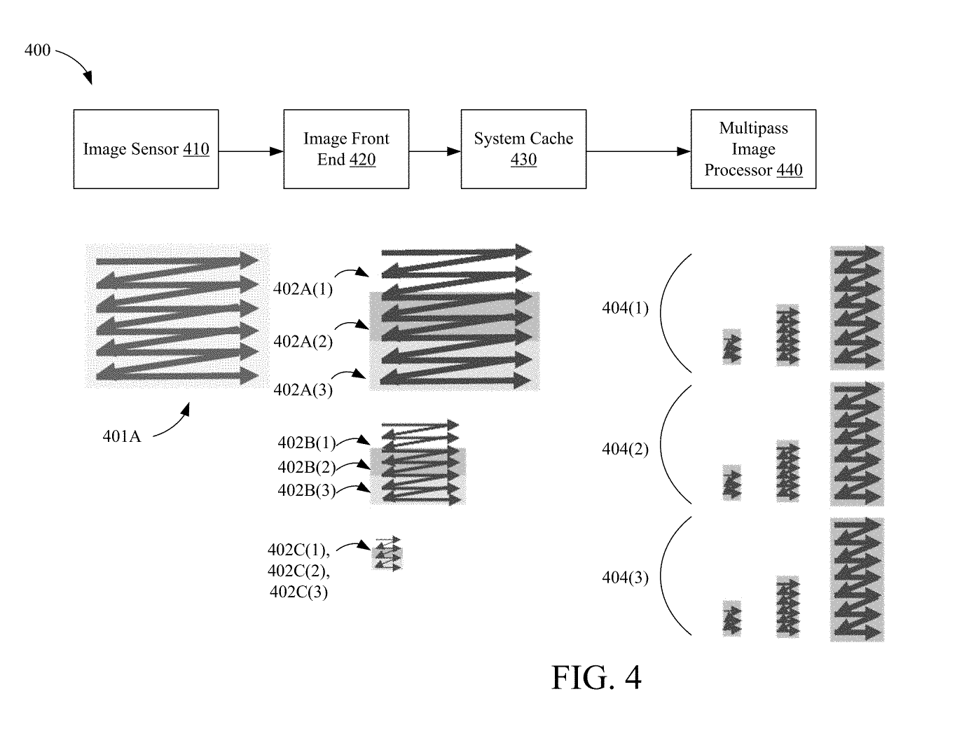

FIG. 4 shows an example stripe-based multi-pass image processing system 400, in accordance with the example embodiments. The stripe-based multi-pass image processing system 400 includes an image sensor 410, an IFE 420, system cache 430, and a MPIP 440. Note that MPIP 440 may include one or more hardware or software stages of an image processing pipeline (not shown for simplicity). In the example of FIG. 4, an image may be captured by image sensor 410 and provided to IFE 420 as a sequence of raster lines. The IFE 420 may then group the received raster lines into a plurality of full-scale horizontal stripes 402A(1)-402A(3), and store them in a system cache 430. Each of the plurality of full-scale horizontal stripes may include a number of raster lines corresponding to a width of one or more line buffers of the system 400 (e.g., in MPIP 440). In some example embodiments, the horizontal stripes may correspond to overlapping horizontal stripes. For example, one or more raster lines at the bottom of one horizontal stripe may be repeated at the top of a subsequent horizontal stripe. Such overlapping may be beneficial for multi-dimensional filtering and other image processing applications, and the one or more repeated raster lines may be removed after processing is completed.

IFE 420 may further generate one or more corresponding sets of downscaled horizontal stripes 402B(1)-402B(3) and 402C(1)-402C(3), where each downscaled horizontal stripe is a downscaled version of one of the full-scale horizontal stripes. For example, the downscaled horizontal stripes 402B(1) and 402C(1) may correspond to full-scale horizontal stripe 402A(1), downscaled horizontal stripes 402B(2) and 402C(2) may correspond to full-scale horizontal stripe 402A(2), and downscaled horizontal stripes 402B(3) and 402C(3) may correspond to full-scale horizontal stripe 402A(3). These corresponding downscaled horizontal stripes may also be stored in system cache 430. In some embodiments, the one or more corresponding sets of downscaled horizontal stripes may comprise a 1:4 resolution set and a 1:16 resolution set of horizontal stripes—for UHD, a full-scale resolution may be 3840×2160 pixels, a 1:4 resolution may be 960×540 pixels, and a 1:16 resolution may be 240×135 pixels. Note that while, in FIG. 4, system cache 430 is shown to store the full-scale horizontal stripes and the downscaled horizontal stripes, in accordance with other embodiments, off-chip memory such as a RAM (not shown for simplicity) may be used for storing the horizontal stripes.

After a full-scale horizontal stripe and its corresponding downscaled horizontal stripes are stored, the MPIP 440 may read these stripes in a rotated (e.g., vertical) orientation. In particular, MPIP 440 may read a stored full-scale horizontal stripe as if it were a full-scale “vertical” stripe, and may read the corresponding downscaled horizontal stripes as if they were downscaled vertical stripes. In some other embodiments, the IFE 420 may store the full-scale horizontal stripes 402A(1)-402A(3) and the corresponding downscaled horizontal stripes 402B(1)-402B(3) and 402C(1)-402C(3) in the system cache 430 in a rotated orientation (e.g., storing the horizontal stripes in the vertical orientation). In such embodiments, the MPIP 440 may not need to read the stripes in a rotated orientation.

Among other benefits, rotating the horizontal stripes before processing may allow each stripe to be processed as it is received by the image processing system 400, rather than waiting for the full image 401A to be captured by image sensor 410 and received by IFE 420. Instead, the MPIP 440 may begin processing individual stripes before all subsequent stripes have been received. For example, with respect to FIG. 4, the MPIP 440 may initially process a first set of stripes 404(1), corresponding to horizontal stripes 402C(1), 402B(1) and 402A(1). After processing the first set of stripes 404(1), the MPIP 440 may process a second set of stripes 404(2), corresponding to horizontal stripes 402C(2), 402B(2), and 402A(2). Finally, the MPIP 440 may process a third set of stripes 404(3), corresponding to horizontal stripes 402C(3), 402B(3), and 402A(3). In the example of FIG. 4, MPIP 440 does not need to wait for the complete image 401A to be received by the IFE 420, because the first set of stripes 404(1) may be available for processing before the raster lines corresponding to all subsequent full-scale horizontal stripes (e.g., corresponding to the second set of stripes 404(2) or the third set of stripes 404(3)) are received by the IFE 420. As described above, because each horizontal stripe contains information from a contiguous set of adjacent raster lines of the full image 401 (e.g., rather than portions of multiple non-adjacent raster lines), rotating the stripes allows the MPIP 440 to process each horizontal stripe as it is acquired by the image sensor 410, rather than waiting for all of the horizontal stripes to be acquired.

The example embodiments may reduce frame latency of conventional multi-pass image processing systems. For example, conventional multi-pass image processing systems require at least one frame delay due to the sequential dependence for such systems. In contrast, as described above, the present embodiments may reduce this frame latency by allowing stripes to be processed as they are received, which may reduce preview or display latency by up to a full frame. Improvements in preview/display latency may be important for applications requiring actions to be performed in real-time responsive to the processed images, such as for computer vision, or for remote vehicle navigation. For example, the reduced preview/display latency may be helpful for navigation of remote controlled vehicles (for example quadcopters or “drones”), as such navigation often depends on images captured and processed from a vehicle-mounted camera.

In some example embodiments, two or more of the sets of stripes—such as sets 404(1)-404(3) of FIG. 4—may be processed in parallel, rather than sequentially. Such parallel processing may further reduce processing time and frame delays in example multi-pass image processing systems.

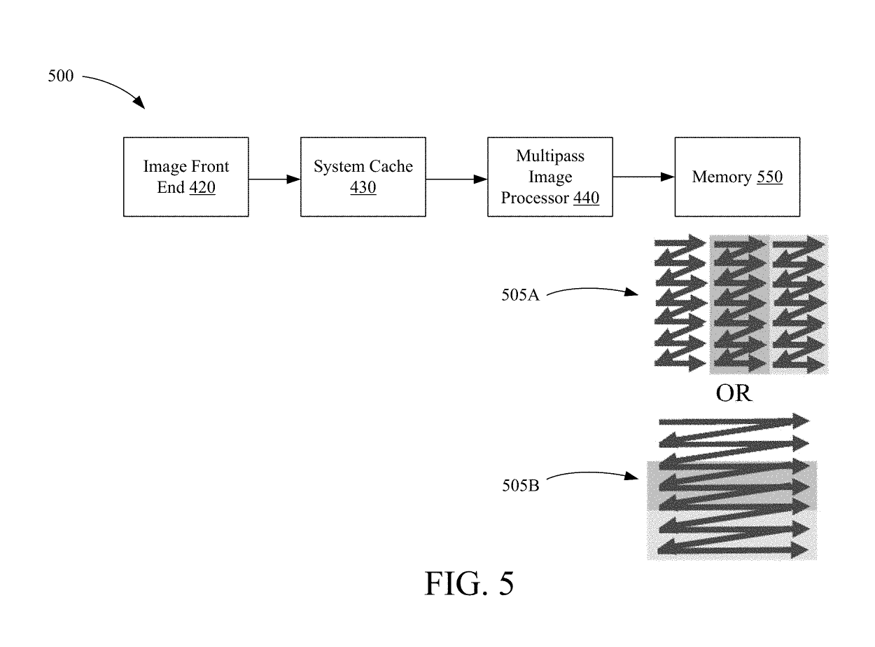

After each set of stripes 404(1)-404(3) has been processed, the resulting processed full-scale image may be stored in memory, such as a RAM. For example, with reference to the multi-pass image processing system 500 shown in FIG. 5, after an image has been received by IFE 420, stored in system cache 430, and processed by MPIP 440 (e.g., as described above with respect to FIG. 4), the resulting sets of stripes 404(1)-404(3) may be rotated to match an original orientation of the full-scale image received by the IFE 420. Alternatively, the sets of stripes 404(1)-404(3) may be stored in the rotated orientation in which they were processed. In one example, after full-scale image 401A has been processed, it may be stored in a memory 550 as image 505A, in the orientation in which the MPIP 440 processed the sets of stripes 404(1)-404(3). Alternatively, the processed full-scale image may be stored as image 505B, in an orientation matching the original orientation of image 401A. If the image is stored in memory 505 in the rotated orientation, a downstream module reading the processed image 505A may read the processed image in a rotated orientation to match the original orientation of image 401A. For example, with respect to the implementations described with respect to FIGS. 4-5, the processed full-scale image may be stored in a rotated orientation—the orientation in which the vertical stripes were processed by the MPIP—and a downstream module may read the image rotated to the original orientation of the captured image—the orientation of the horizontal stripes generated by the IFE. Alternatively, the processed full-scale image may be rotated and stored in the original orientation of the captured image, and downscale modules may not need to rotate the processed image but read it in the same orientation in which it was stored. Example downstream modules may be a display for rendering the processed image, further processing cores, such as a video encoding core, or an image compression core.

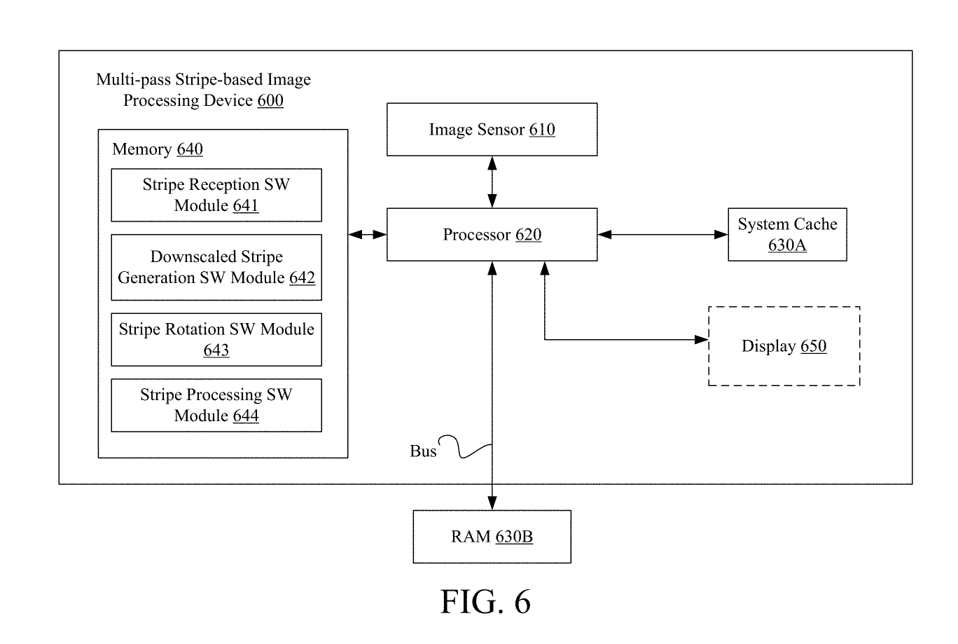

FIG. 6 shows an example multi-pass stripe-based image processing device 600, which may implement the multi-pass image processing system of FIGS. 4-5. The image processing device 600 may include an image sensor 610, a processor 620, and a memory 640. The image sensor 610 may be used for capturing images for processing. Image sensor 610 may be coupled to processor 620. Processor 620 may in turn be locally coupled to a system cache 630A and/or coupled via a bus to a RAM 630B. Processor 620 may also be coupled to the memory 640 and optionally to a display 650. While not shown in FIG. 6 for simplicity, processor 620 may also be coupled to one or more further image processing cores, such as a video encoding core, one or more image compression cores, and so on.

Image sensor 610 may include one or more image sensors such as one or more color filter arrays (CFAs) arranged on a surface of the respective sensors, and may be coupled directly or indirectly to processor 620. Image sensor 610 may alternatively include other types of image sensors for capturing images. For example, image sensor 610 may include arrays of solid state sensor elements such as complementary metal-oxide semiconductor (CMOS) sensor elements, or other appropriate image sensor devices.

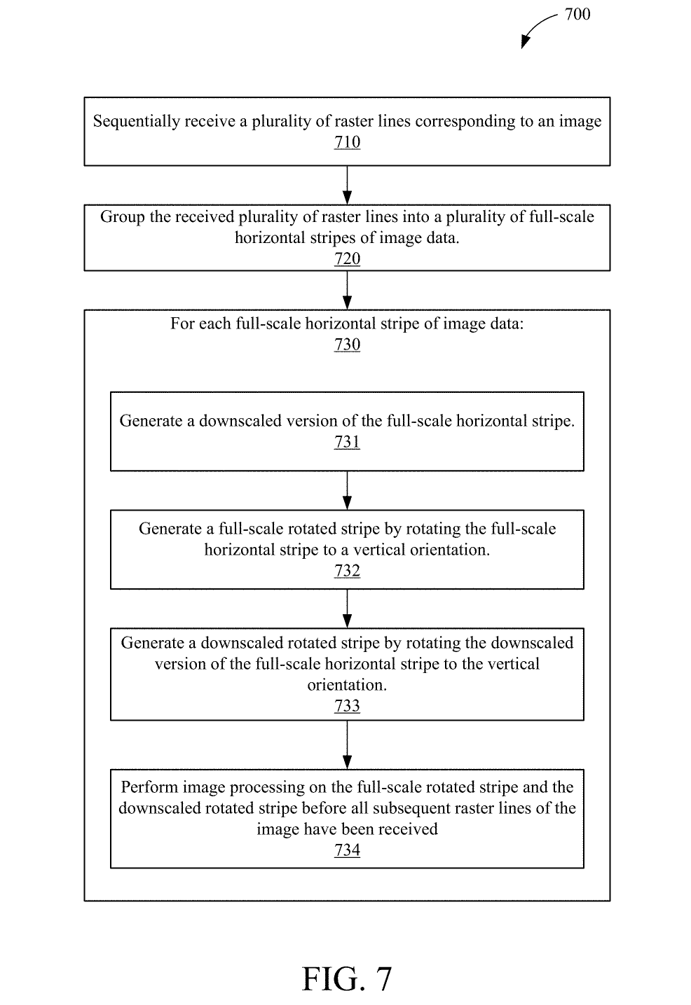

Memory 640 may include a non-transitory computer-readable medium (e.g., one or more nonvolatile memory elements, such as EPROM, EEPROM, Flash memory, a hard drive, and so on) that may store at least the following software (SW) modules:
a stripe reception software module 641 to receive raster lines of image data from the image sensor 610, and to group the received raster lines into stripes of image data (e.g., as described for one or more operations of FIG. 7);
a downscaled stripe generation software module 642 to generate one or more downscaled stripes of image data corresponding to each full-scale stripe of image data (e.g., as described for one or more operations of FIG. 7);
a stripe rotation software module 643 to read horizontal stripes of image data in a rotated orientation, and (optionally) rotate processed full-scale images to match an original orientation of a received image (e.g., as described for one or more operations of FIG. 7); and
a stripe processing software module 644 to process rotated stripes of full-scale and downscaled image data (e.g., as described for one or more operations of FIG. 7).
   Each software module includes instructions that, when executed by processor 620, cause the device 600 to perform the corresponding functions. The non-transitory computer-readable medium of memory 640 thus includes instructions for performing all or a portion of the operations depicted in FIG.7.

Processor 620 may be any suitable one or more processors capable of executing scripts or instructions of one or more software programs stored in device 600 (e.g., within memory 640). Further, processor 620 may include one or more stages of an image processing pipeline. For example, processor 620 may execute the stripe reception software module 641 to receive raster lines of image data from the image sensor 610, and to group the received raster lines into stripes of image data. Processor 620 may also execute the downscaled stripe generation software module 642 to generate one or more downscaled stripes of image data corresponding to each full-scale stripe of image data. Processor 620 may further execute the stripe rotation software module 643 to read horizontal stripes of image data in a rotated orientation, and (optionally) rotate processed full-scale images to match an original orientation of a received image. Processor 620 may further execute the stripe processing software module 644 to process rotated stripes of full-scale and downscaled image data.

FIG. 7 shows a flowchart depicting an example operation 700 for processing image data, according to the example embodiments. For example, the operation 700 may be implemented by suitable image processing systems such as multi-pass image processing systems 400 and 500 of FIGS. 4 and 5, respectively, or by multi-pass stripe-based image processing device 600 of FIG. 6, or other suitable systems and devices.

A plurality of raster lines may be sequentially received, where the plurality of raster lines corresponds to an image (710). The plurality of raster lines may be grouped into a plurality of full-scale horizontal stripes of image data (720). For example, the plurality of raster lines may be received from image sensor 410 of FIG. 4 or received by IFE 420 of FIGS. 4-5, or by executing stripe reception software module 641 of device 600 of FIG. 6. In some implementations, each full-scale horizontal stripe may include a number of raster lines corresponding to a width of one or more line buffers used for processing the image in a multi-pass image processor (MPIP). For each full-scale horizontal stripe of the image data a number of operations may be performed (730). For example, a downscaled version of the full-scale horizontal stripe of image data may be generated (731). For example, the downscaled version of the full-scale horizontal stripe may be generated by IFE 420 of FIGS. 4 and 5, or by executing downscaled stripe generation software module 642 of device 600 of FIG. 6. For some implementations, the received full-scale horizontal stripe and the downscaled version of the full-scale horizontal stripe may be stored in a memory, such as a local cache memory or a random-access memory (RAM). In some embodiments, multiple downscaled versions of the full-scale horizontal stripe may be generated. The multiple downscaled versions of the full-scale horizontal stripes may include at least a 1:4 resolution stripe and a 1:16 resolution stripe. The full-scale horizontal stripe may then be rotated to a vertical orientation, to generate a full-scale rotated stripe (732). Similarly, the downscaled version of the full-scale horizontal stripe may be rotated to the vertical orientation, to generate a downscaled rotated stripe (733). In some examples, the rotation may be performed by IFE 420 or MPIP 440 of FIGS. 4-5, or by executing stripe rotation software module 643 of device 600 of FIG. 6. If multiple downscaled versions of the full-scale horizontal stripe are generated, then each of the multiple downscaled versions may be rotated to the vertical orientation, generating multiple downscaled rotated stripes. In some implementations, the MPIP 440 may read stored horizontal stripes in a vertical orientation, and in some other implementations the IFE 420 may store the stripes in a vertical orientation.

After generating the full-scale rotated stripe and the downscaled rotated stripe of image data, the full-scale rotated stripe and the downscaled rotated stripe may be processed before all subsequent raster lines of the image have been received (734). For example, the full-scale rotated stripe and downscaled rotated stripe may be processed by MPIP 440 of FIGS. 4-5, or by executing stripe processing software module 644 of FIG. 6. The rotated stripes may be processed in an increasing size order. For example, if multiple downscaled rotated stripes are generated, the lowest resolution downscaled stripe may be processed first, proceeding to the highest resolution stripe (the full-scale rotated stripe). In some embodiments, a frame output may be generated based on the processed full-scale rotated stripe and the downscaled rotated stripe, and the frame output may be rotated to match an orientation of the image.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for processing image data, the method comprising:
sequentially receiving a plurality of raster lines corresponding to an image;
grouping the plurality of raster lines into a plurality of full-scale horizontal stripes of image data; and
for each full-scale horizontal stripe of image data:
generating a first downscaled version of the full-scale horizontal stripe;
generating a full-scale rotated stripe by rotating the full-scale horizontal stripe to a vertical orientation;
generating a first downscaled rotated stripe by rotating the first downscaled version of the full-scale horizontal stripe to the vertical orientation; and
performing image processing on the full-scale rotated stripe and the first downscaled rotated stripe before all subsequent raster lines of the image have been received.

2. The method of claim 1, further comprising, for each full-scale horizontal stripe of image data, storing a full-scale stripe of image data in a memory.

3. The method of claim 2, wherein the memory is a local cache memory.

4. The method of claim 2, wherein the memory is a random-access memory (RAM).

5. The method of claim 2, wherein the storing comprises, for each full-scale horizontal stripe of image data, storing the full-scale horizontal stripe and the first downscaled version of the full-scale horizontal stripe.

6. The method of claim 2, wherein the storing comprises, for each full-scale horizontal stripe of image data, storing the full-scale rotated stripe and the first downscaled rotated stripe.

7. The method of claim 1 further comprising:
generating a frame output based on the processed full-scale and downscaled rotated stripes and rotating the frame output to match an orientation of the image.

8. The method of claim 1, wherein each full-scale horizontal stripe includes a number of raster lines corresponding to a width of one or more line buffers used for processing the full-scale rotated stripe.

9. The method of claim 1, further comprising, for each full-scale horizontal stripe:
generating a second downscaled version of the full-scale horizontal stripe; and
generating a second downscaled rotated stripe by rotating the second downscaled version of the full-scale horizontal stripe to the vertical orientation.

10. The method of claim 9, wherein for each full-scale horizontal stripe the image processing is performed on the full-scale rotated stripe, the first downscaled rotated stripe, and the second downscaled rotated stripe in an order from lowest resolution to highest resolution.

11. An image processing system configured to process an image, the image processing system comprising:
an image front end (IFE) to sequentially receive a plurality of raster lines corresponding to the image, and grouping the plurality of raster lines into a plurality of full-scale horizontal stripes of image data;
one or more processors; and
a first memory storing instructions that, when executed by the one or more processors, cause the image processing system to, for each full-scale horizontal stripe of image data:
generate a first downscaled version of the full-scale horizontal stripe;
generate a full-scale rotated stripe by rotating the full-scale horizontal stripe to a vertical orientation;
generate a first downscaled rotated stripe by rotating the first downscaled version of the full-scale horizontal stripe to the vertical orientation; and
perform image processing on the full-scale rotated stripe and the first downscaled rotated stripe before all subsequent raster lines of the image have been received by the IFE.

12. The image processing system of claim 11, wherein execution of the instructions further causes the image processing system to, for each full-scale horizontal stripe of image data:
store a full-scale stripe of image data in at least one of the first memory or a second memory.

13. The image processing system of claim 12, wherein the second memory is a local cache memory.

14. The image processing system of claim 12, wherein the second memory is a random-access memory (RAM).

15. The image processing system of claim 12, wherein execution of the instructions for storing the full-scale stripe of image data causes the image processing system to, for each full-scale horizontal stripe of image data:
store the full-scale horizontal stripe and the first downscaled version of the full-scale horizontal stripe.

16. The image processing system of claim 12, wherein execution of the instructions for storing the full-scale stripe of image data causes the image processing system to, for each full-scale horizontal stripe of image data:
store the full-scale rotated stripe and the first downscaled rotated stripe.

17. The image processing system of claim 11, wherein execution of the instructions further causes the image processing system to:
generate a frame output based on the processed full-scale and downscaled rotated stripes and to rotate the frame output to match an orientation of the image.

18. The image processing system of claim 11, wherein each of the full-scale horizontal stripes includes a number of raster lines corresponding to a width of one or more line buffers used for processing the full-scale rotated stripe.

19. The image processing system of claim 11, wherein execution of the instructions further causes the image processing system to, for each full-scale horizontal stripe:
generate a second downscaled version of the full-scale horizontal stripe; and
generate a second downscaled rotated stripe by rotating the second downscaled version of the full-scale horizontal stripe to the vertical orientation.

20. The image processing system of claim 19, wherein the image processing is performed on the full-scale rotated stripe, the first downscaled rotated stripe, and the second downscaled rotated stripe in an order from lowest resolution to highest resolution.

21. A non-transitory computer-readable storage medium storing instructions that, when executed by one or more processors of an image processor, cause the image processor to:
sequentially receive a plurality of raster lines corresponding to an image;
group the plurality of raster lines into a plurality of full-scale horizontal stripes of image data; and
for each full-scale horizontal stripe of image data:
generate a first downscaled version of the full-scale horizontal stripe;
generate a full-scale rotated stripe by rotating the full-scale horizontal stripe to a vertical orientation;
generate a first downscaled rotated stripe by rotating the first downscaled version of the full-scale horizontal stripe to the vertical orientation; and
perform image processing on the full-scale rotated stripe and the first downscaled rotated stripe before all subsequent raster lines of the image have been received.

22. The non-transitory computer-readable storage medium of claim 21, wherein execution of the instructions further causes the image processor to, for each full-scale horizontal stripe of image data:
store a full-scale stripe of image data in a memory.

23. The non-transitory computer-readable storage medium of claim 22, wherein the memory is a local cache memory.

24. The non-transitory computer-readable storage medium of claim 22, wherein the memory is a random-access memory (RAM).

25. The non-transitory computer-readable storage medium of claim 22, wherein execution of the instructions for storing the full-scale stripe of image data causes the image processor to, for each full-scale horizontal stripe of image data:
store the full-scale horizontal stripe and the first downscaled version of the full-scale horizontal stripe.

26. The non-transitory computer-readable storage medium of claim 22, wherein execution of the instructions for storing the full-scale stripe of image data causes the image processor to, for each full-scale horizontal stripe of image data:
store the full-scale rotated stripe and the first downscaled rotated stripe.

27. The non-transitory computer-readable storage medium of claim 21, wherein each of the full-scale horizontal stripes includes a number of raster lines corresponding to a width of one or more line buffers used for processing the full-scale rotated stripe.

28. The non-transitory computer-readable storage medium of claim 21, wherein execution of the instructions further causes the image processor to, for each full-scale horizontal stripe of image data:
generate a second downscaled version of the full-scale horizontal stripe; and
generate a second downscaled rotated stripe by rotating the second downscaled version of the full-scale horizontal stripe to the vertical orientation.

29. The non-transitory computer-readable storage medium of claim 28, wherein the image processing is performed on the full-scale rotated stripe, the first downscaled rotated stripe, and the second downscaled rotated stripe in an order from lowest resolution to highest resolution.

30. An image processing system configured to process an image, the image processing system comprising:
means for sequentially receiving a plurality of raster lines corresponding to an image;
means for grouping the plurality of raster lines into a plurality of full-scale horizontal stripes of image data; and
for each full-scale horizontal stripe of image data:
means for generating a first downscaled version of the full-scale horizontal stripe;
means for generating a full-scale rotated stripe by rotating the full-scale horizontal stripe to a vertical orientation;
means for generating a first downscaled rotated stripe by rotating the first downscaled version of the full-scale horizontal stripe to the vertical orientation; and
means for performing image processing on the full-scale rotated stripe and the first downscaled rotated stripe before all subsequent raster lines of the image have been received.
